(19) United States
(12) Patent Application Publication
(10) Pub. No.: US 2006/0168618 A1
(43) Pub. Date: Jul. 27, 2006

(54) System and method for home automation using wireless control rf remocon module based on network

(76) Inventor: Dong-Wook Choi, Seoul (KR)

Correspondence Address: Peter T Kwon;Global Wide International Patent Service, Kangnam P O box 2301, Seoul, 135 242, KR

(21) Appl. No.: 10/547,020

(22) PCT Filed: Mar. 29, 2004
(86) PCT No.: PCT/KR04/00715

§ 371 Date: Aug. 23, 2005

(30) Foreign Application Priority Data
Apr. 1, 2003 (KR) 10-2003-0020635

(51) Int. Cl. H04N 5/445; G06F 13/00

(52) U.S. Cl. 725/37

(57) ABSTRACT

A home automation system using an infrared (IR)/radio frequency (RF) integration remote control module based on a network. At least one IR/RF integration remote control module (100) is disposed at a predetermined location of a home automation region. The IR/RF integration remote control module (100) with a wireless interface function integrates an RF modulation/reception/transmission function and an IR modulation/reception/transmission. A set-top box (200) is appropriately disposed so that it can carry out an interface function for controlling the IR/RF integration remote control module (100) and a wired/wireless Internet access function. The set-top box (200) receives various control commands over an Internet network using transmission control protocol/Internet protocol (TCP/IP) and controls the IR/RF integration remote control module (100). Even though various pieces of equipment using the conventional IR reception/transmission scheme or a new electronic product equipped with an RF module is added to the home automation system using an RF modulation scheme, an automation operation and a bidirectional control operation based on the integrated IR and RF transmission scheme can be appropriately carried out. Thus, the home automation system and method can be cost-effectively and conveniently implemented.

### TECHNICAL FIELD

The present invention relates to a home automation system and method using a radio frequency (RF) remote control module based on a network, and more particularly to a home automation system and method that can perform various operations and bidirectional control for home automation by installing an RF remote control module with a wireless interface function at a specific region capable of ensuring a visual field so that a conventional problem of ensuring the visual field can be addressed when a home network including pre-existing home appliances is controlled by a remote controller at a remote place or at home, by disposing a set-top box with an interface function necessary for controlling the RF remote control module and a wireless Internet access function, and by allowing the set-top box to receive various control commands through an Internet network and to appropriately control the RF remote control module.

### BACKGROUND ART

Generally, in order to remotely various electronic products, a remote controller emitting unidirectional infrared (IR) light containing specific data/information is employed. Light receivers mounted in various electronic products are constituted to receive the IR light emitted from the remote controller so that it can perform a remote control operation.

However, it is inconvenient that the conventional remote controller's operator must manipulate the remote controller at a place ensuring a visual field between a light emitter of the remote controller and a light receiver of an electronic product because of reflection properties of the IR light different from transmission properties of ultraviolet light.

Where an electronic product is behind a wall or an obstacle within a house, it cannot be appropriately controlled because of these properties of light. Similarly, the conventional remote controller performing only the unidirectional control may not appropriately control the electronic product in the above-described situation. For this reason, there is a problem in that the operator must move to the electronic product to be controlled and give a command to the electronic product at a local area without any obstacle.

Where different types of IR identification codes are adopted in various electronic products, there is another problem in that different remote controllers based on the different types of identification codes must be employed.

To address this problem, an integration remote controller has been introduced recently. However, because this integration remote controller also adopts a form of IR transmission and reception, there is still a problem in that the IR light is reflected in a state in which the visual field is not ensured. Where a new electronic product out of a range of IR codes preset within the integration remote controller is additionally present, an additional control function or an update task for changing a code is impossible.

### DISCLOSURE OF THE INVENTION

Technical Subjects to be Solved by the Invention

Therefore, the present invention has been made in view of the above problems, and it is one object of the present invention to provide a home automation system and method that can construct a network of electronic products located at home, a remote place, etc. and can control the electronic products also at a long distance without limiting a distance of a visual field.

It is another object of the present invention to provide a home automation system and method that can ensure system extendibility so that control data of an electronic product newly added to the home automation system can be updated in real time.

The above and other objects, features and other advantages of the present invention will be described in detail in the following description.

Solution

In accordance with one aspect of the present invention, the above and other objects can be accomplished by the provision of a home automation system using a radio frequency (RF) remote control module based on a network, comprising: at least one wired/wireless computer terminal equipped with a built-in wired/wireless Internet module for carrying out a wired/wireless data communication process over an Internet network and for carrying out a remote control/monitoring process for various electronic products over the Internet network; an RF remote control module having an additional wireless Internet function added to an integration remote control function that integrates remote control functions for the electronic products; and a set-top box equipped with a built-in wired/wireless Internet module that performs a wireless interface function for controlling the RF remote control module and an Internet access function, the set-top box receiving a remote control/monitoring command for each of the electronic products from the wired/wireless computer terminal over the Internet network and applying the received remote control/monitoring command to the RF remote control module so that the RF remote control module can remotely control the electronic products.

Preferably, the home automation system further comprises an update server having a built-in wired/wireless Internet module for continuously transmitting control data associated with at least one new electronic product to the wired/wireless computer terminal over the Internet network so that the wired/wireless computer terminal can perform an update operation.

Preferably, the RF remote control module comprises: an RF transceiver for receiving RF data from the set-top box, demodulating the received RF data, converting the demodulated RF data into digital data, and transmitting the digital data; a central processing unit (CPU) for receiving the digital data from the RF transceiver and performing a corresponding operation so that the digital data can be transmitted to each of the electronic products according to a predetermined process; and an infrared (IR) transceiver for receiving the digital data from the CPU, carrying out a modulation operation for the received digital data, generating an optical signal capable of being transmitted to each of the electronic products, and transmitting the optical signal to each of the electronic products.

Preferably, the RF remote control module comprises: a camera interface for detecting a state of each electronic product to be controlled and transmitting state data to the set-top box. The detected state data is set so that it can be transmitted in the form of still-pictures or real-time moving pictures.

Moreover, the state of an electronic product can be detected over a wired/wireless Internet network using a wired/wireless web camera in real time without special support of the set-top box.

In accordance with another aspect of the present invention, the above and other objects can be accomplished by the provision of a home automation method using a radio frequency (RF) remote control module based on a network, comprising the steps of: allowing the RF remote control module to receive data from a set-top box; determining whether or not the received data is remote control data; determining whether or not the determined data is processable manufacturer data; determining whether or not the determined data is processable equipment data; determining whether or not the determined data is a processable command; if the determined data is a processable command, retrieving data of a corresponding command from a table; combining remote control data according to the retrieved command data; and carrying out an infrared (IR) modulation operation for the combined control data, transmitting a result of the IR modulation operation to corresponding equipment, and carrying out a control operation.

Advantageous Effects

In accordance with the present invention, a radio frequency (RF) remote control module serving as a remote controller is disposed at a proper location ensuring a visual field between electronic products, such that no reflection or cut-off action of infrared (IR) light is incurred and hence the RF remote control module can be reliably controlled. In accordance with the present invention, a home automation system additionally having a camera control function can perform a bidirectional control operation by confirming a state of an electronic product and then sending a control signal, differently from the conventional remote controller performing only a unidirectional control function. Thus, the home automation system can appropriately perform a control operation in real time according to a current state of the electronic product.

Where a plurality of electronic products adopt different types of infrared (IR) identification codes or a new electronic product is added to the home automation system, a set-top box can download data from an update server over an Internet network and can perform an update operation. For this reason, the home automation system is extendable, such that the newly added electronic product can be appropriately controlled. Until the electronic product ceases to function, the home automation system can appropriately use and control the electronic product.

### BRIEF DESCRIPTION OF THE DRAWINGS

FIG. 1 is a conceptual diagram illustrating a home automation system using a radio frequency (RF) remote control module based on a network in accordance with the present invention;

FIG. 2 is a block diagram illustrating the network-based RF remote control module in accordance with the present invention; and

FIG. 3 is a flowchart illustrating an operation of the home automation system in accordance with the present invention.

### BEST MODE FOR CARRYING OUT THE INVENTION

Now, preferred embodiments of the present invention will be described in detail with reference to the annexed drawings.

In the following description, a detailed description of known functions and configurations incorporated herein will be omitted when it may make the subject matter of the present invention rather unclear. The words or expressions to be described below are defined on the basis of functions associated with the present invention. The defined words or expressions can be changed according to intentions or usual practices of a producer. Thus, the terminology can be based on the entire contents of the present invention.

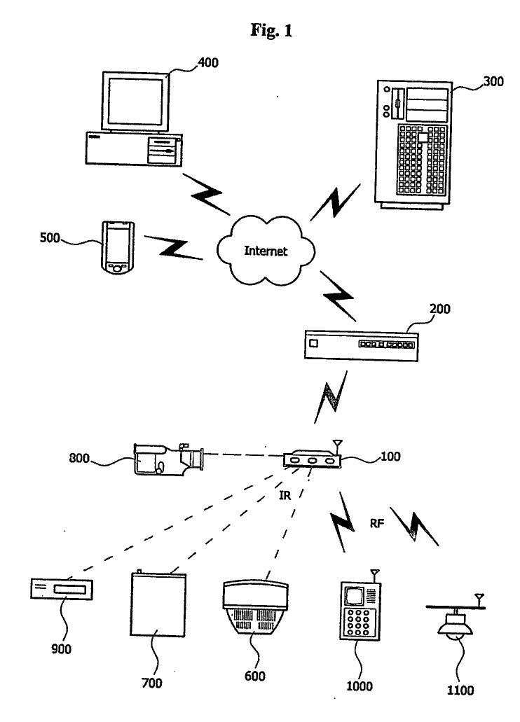

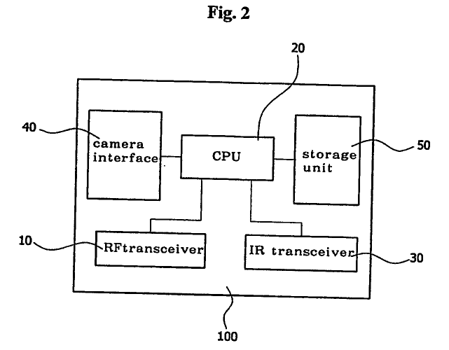

FIG. 1 is a total conceptual diagram illustrating a home automation system using a remote controller based on a network in accordance with the present invention. In FIG. 1, reference numeral 100 denotes a radio frequency (RF) remote control module 100 serving as the remote controller. A basic operation of the RF remote control module 100 will be described with reference to a block diagram illustrating the RF remote control module 100 shown in FIG. 2.

As shown in a lower portion of FIG. 1, the RF remote control module 100 is disposed at a predetermined place ensuring a visual field between various electronic products such as a television (TV) 600, a refrigerator 700, etc. The reason that the RF remote control module 100 is disposed at the predetermined place ensuring the visual field is to take into account transmission and reflection properties of infrared (IR) light irradiated from an IR transceiver 30.

A central processing unit (CPU) 20 provided in the RF remote control module 100 stores a code table including all IR codes mapped to the electronic products such as the TV 600, the refrigerator 700, etc., such that the RF remote control module 100 serves as an IR/RF integration remote control module.

In order that remote control data to be transmitted to each electronic product can be generated in response to command data applied from a set-top box 200 to be described below, the CPU 20 generates the remote control data appropriate for the electronic product using the data received from the set-top box 200 or an internally downloaded table and then transmits the generated remote control data to the IR transceiver 30.

The IR transceiver 30 converts the remote control data applied from the CPU 20 into an optical signal, and irradiates the optical signal to the electronic product such as the TV 600, the refrigerator 700 or etc.

As shown in FIG. 2, a camera interface 40 is constituted so that it can transmit data to the CPU 20 or receive data from the CPU 20. The camera interface 40 detects a state of a target electronic product to be controlled by the RF remote control module 100 to generate state data, and then transmits the generated state data to the CPU 20. The CPU 20 can transmit the state data to the set-top box 200 through an RF transceiver 10. The set-top box 200 transmits the state data to a wired/wireless computer terminal 400 or 500 serving as a control data source over an Internet network, thereby transmitting currently monitored state data corresponding to a control command.

In this case, the state data can be transmitted in the form of a still-picture file or real-time moving-picture file at predetermined time intervals.

Moreover, the set-top box 200 shown in FIG. 1 is equipped with an RF module (not shown) having a wireless interface function using an RF so that the set-top box 200 can control the RF remote control module 100. The set-top box 200 is equipped with an Internet access modem (not shown) so that it can receive a control command and a monitoring command from the Internet network or provide various data units through the Internet network.

The set-top box 200 is constituted so that it integrates several division regions and manages the integrated division regions according to an arrangement state of electronic products at home. The set-top box 200 can control and monitor a plurality of RF remote control modules 100 disposed at a plurality of regions at home.

Moreover, the set-top box 200 can be connected to the computer terminal 400 or the mobile terminal 500 over the Internet network as described above, and can transmit and receive response data according to control/monitoring data applied from the wired/wireless computer terminals such as the computer terminal 400 and the mobile terminal 500.

An update server 300 equipped with a built-in wired/wireless Internet module transmits data associated with a new electronic product capable of being continuously added, for example, manufacturer data, equipment data and various command data units, etc., to the wired/wireless computer terminals 400 and 500 over the Internet network, such that the wired/wireless computer terminals 400 and 500 can carry out an update operation.

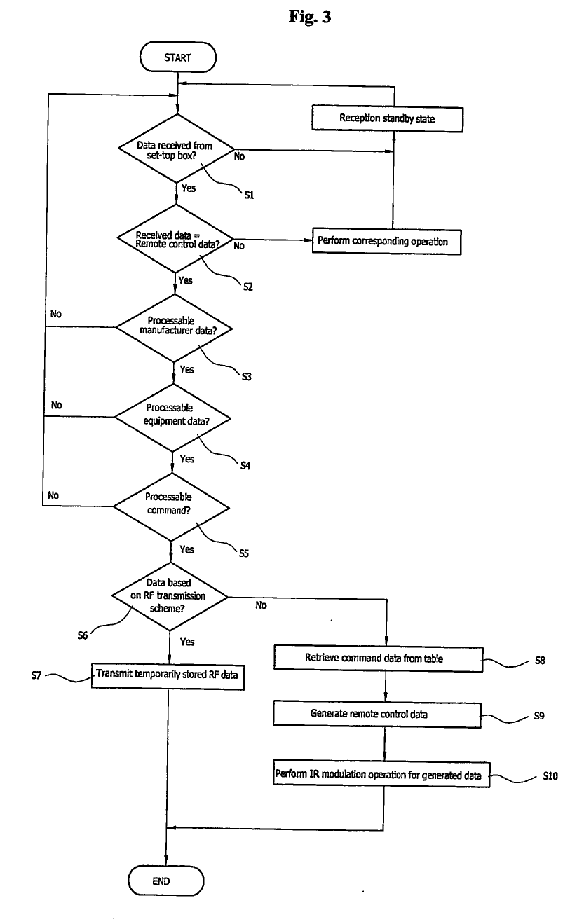

FIG. 3 is a flowchart illustrating an operation of the home automation system in accordance with the present invention. An initial state of the RF remote control module 100 is a data reception standby state for receiving data from the set-top box 200 after software of the RF remote control module 100 initializes equipment. FIG. 3 shows a process for receiving data from the set-top box 200 and processing the received data.

In the home automation method using the RF remote control module 100 based on the network in accordance with the present invention shown in FIG. 3, the RF transceiver 10 provided in the RF remote control module 100 receives RF data from the set-top box 200, demodulates the received RF data and applies the demodulated RF data to the CPU 20, at a data reception step S1.

Moreover, the RF data applied to the RF remote control module 100 by the set-top box 200 corresponds to a result of a conversion operation for control/monitoring data applied from the wired/wireless computer terminal 400 or 500 over the Internet network.

The CPU 20 provided in the RF remote control module 100 performs a data check step S2 to determine whether or not the data received at the above step SI is remote control data.

At this point, if the received data is remote control data as a result of the determination at the above step S2, a manufacturer data determination step S3 is carried out. On the other hand, if the received data is not remote control data as a result of the determination at the above step S2, the CPU 20 performs a corresponding operation based on the received data and then returns to the reception standby state.

At step S3, a manufacturer data determination operation is carried out to determine whether or not the data determined at the above step S2 is processable manufacturer data. At this point, for example, a method for decoding a manufacturer identification or identity (ID) encoded in part of a packet of the data determined at the above step S2 can be used. If the data is processable manufacturer data as a result of the determination at the above step S3, a determination is made as to whether or not the data is processable equipment data at step S4.

On the other hand, if the data is not processable manufacturer data as a result of the determination at the above step S3, the CPU 20 processes the received data as fail data and returns to the initial state, that is, the CPU 20 returns to the data reception standby state. If update data of a new home appliance has been transmitted from the update server 300 and an update operation has been carried out in the wired/wireless computer terminal 400 or 500, the received data can be determined to be processable manufacturer data as the result of the determination at the above step S3.

At the above equipment data determination step S4, the determination is made as to whether or not the data determined at the above step S3 is processable equipment data. If the data is included in a list of processable equipment data units, the CPU 20 proceeds to a command determination step S5. On the other hand, if the data is not processable equipment data, the CPU 20 processes the data as fail data, and returns to the data reception standby state. As mentioned in relation to the above step S3, it can be determined that the data is processable equipment data if the update operation has been carried out in the wired/wireless computer terminal 400 or 500.

It is determined, at step SS, whether or not the data is a processable command, that is, a prescribed command such as an ON, OFF, volume-up/down or channel change command, or etc.

If the data is not a processable command as the result of the determination at the above step S5, the CPU 20 processes the received data as fail data, and returns to the data reception standby state as mentioned in relation to the above steps S3 and S4.

If the update operation has been carried out in the wired/wireless computer terminal 400 or 500, it can be determined that the data is a processable command at the above step S5 as mentioned in relation to the above steps S3 and S4.

A determination is made as to whether or not the data is RF data at step S6. According to a result of the determination at the above step S6, temporarily stored RF data is transmitted at step S7. At step S8, the data determined to be the processable command at the above step S5 is retrieved from a command table. At step S9, the CPU 20 combines remote control data according to the data retrieved at the above step S8 and generates the combined remote control data.

The CPU 20 applies the remote control data generated at the above step S9 to the IR transmitter 30. The IR transmitter 30 carries out an IR modulation operation for the remote control data so that it can be transmitted in the form of IR data. Subsequently, the IR transmitter 30 transmits the IR data based on the remote control data to an IR receiver (not shown) of corresponding equipment by means of an IR light emitting diode (LED) at step S10.

The corresponding equipment performs an operation desired by the operator in response to the IR data based on the remote control data transmitted to the IR receiver at the above step S10. The RF remote control module 100 returns to the initial state and returns to the data reception standby state for receiving new remote control data.

The IR data transmitting/receiving method for use in various home appliances has been described in the embodiments of the present invention. However, the home automation system in accordance with the present invention can be compatible with all systems using a controller having central processing functions such as entrance control, gas monitoring, system control, light control, temperature control, etc. that include an IR transceiver, an RF module, etc., as well as home appliances.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their fall scope of equivalents.

1. A home automation system using a radio frequency (RF) remote control module based on a network, comprising:
at least one wired/wireless computer terminal equipped with a built-in wired/wireless Internet module for carrying out a wired/wireless data communication process over an Internet network and for carrying out a remote control/monitoring process for various electronic products over the Internet network;
an RF remote control module having an additional wireless Internet function added to an integration remote control function that integrates remote control functions for the electronic products; and
a set-top box equipped with a built-in wired/wireless Internet module that performs a wireless interface function for controlling the RF remote control module and an Internet access function, the set-top box receiving a remote control/monitoring command for each of the electronic products from the wired/wireless computer terminal over the Internet network and applying the received remote control/monitoring command to the RF remote control module so that the RF remote control module can remotely control the electronic products.

2. The home automation system as set forth in claim 1, further comprising:
an update server having a built-in wired/wireless Internet module for continuously transmitting control data associated with at least one new electronic product to the wired/wireless computer terminal over the Internet network so that the wired/wireless computer terminal can perform an update operation.

3. The home automation system as set forth in claim 1, wherein the RF remote control module comprises:
an RF transceiver for receiving RF data from the set-top box, demodulating the received RF data, converting the demodulated RF data into digital data, and transmitting the digital data;
a central processing unit (CPU) for receiving the digital data from the RF transceiver and performing a corresponding operation so that the digital data can be transmitted to each of the electronic products according to a predetermined process; and
an infrared (IR) transceiver for receiving the digital data from the CPU, carrying out a modulation operation for the received digital data, generating an optical signal capable of being transmitted to each of the electronic products, and transmitting the optical signal to each of the electronic products.

4. The home automation system as set forth in claim 1, wherein the RF remote control module comprises:
a camera interface for detecting a state of each electronic product to be controlled and transmitting state data to the set-top box.

5. A home automation method using a radio frequency (RF) remote control module based on a network, comprising the steps of:
allowing the RF remote control module to receive data from a set-top box;
determining whether or not the received data is remote control data;
determining whether or not the determined data is processable manufacturer data;
determining whether or not the determined data is processable equipment data;
determining whether or not the determined data is a processable command;
if the determined data is a processable command, retrieving data of a corresponding command from a table;
combining remote control data according to the retrieved command data; and
carrying out an infrared (IR) modulation operation for the combined control data, transmitting a result of the IR modulation operation to corresponding equipment, and carrying out a control operation.
